(19) United States
(12) Patent Application Publication
(10) Pub. No.: US 2005/0190407 A1
(43) Pub. Date: Sep. 1, 2005

(54) Image forming apparatus and control method

(75) Inventor: Junnosuke Yokoyama, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/061,436

(22) Filed: Feb. 22, 2005

(30) Foreign Application Priority Data
Feb. 27, 2004 (JP) 2004-054640

(51) Int. Cl. H04N 1/50

(52) U.S. Cl. 358/2.1; 358/1.13; 358/504

(57) ABSTRACT

In an image forming apparatus having a calibration mechanism that adjusts a printer engine for color output, main mode data indicative of information on which of the color output processing or monochrome output processing is used as the main mode is stored in a memory. In accordance with whether the main mode data stored in the memory indicates color output processing or monochrome output processing, execution or non-execution of calibration processing which is performed by the calibration mechanism upon start-up of the apparatus is switched.

### FIELD OF THE INVENTION

The present invention relates to an image forming technique capable of performing color output and monochrome output.

### BACKGROUND OF THE INVENTION

Image forming apparatuses include, for instance, color multi-function peripherals, color copying machines, and facsimile apparatuses. A color multi-function peripheral device (hereinafter referred to as an MFP) is a peripheral unit having multiple functions, such as a copying function, a printer function, and a scanner function. The MFPs and color copying machines, which are capable of performing color output and monochrome output, will collectively be referred to as an image forming apparatus in the present specification.

FIG. 1 is a flowchart describing a procedure of an operation performed by a general image forming apparatus. When the image forming apparatus is turned on or returns from a power saving mode (step S101), calibration is performed (step S102) to correct the hue of the color output of the printer engine and toner output density of respective toners for cyan (C), magenta (M), yellow (Y) and black (K). Upon completion of the calibration operation, print processing such as copying or printing is performed (step S103 to S106) for a received or selected job. In other words, a print operation corresponding to a print job is performed (step S104 to S106). Note that in a case where a selected job does not require print processing, such as a case of FAX transmission or BOX storage, image transfer to the FAX unit or hard disk (HD) is performed even if the printer engine is performing calibration.

Once the calibration is performed, a calibration operation is not performed until the apparatus is turned OFF or shifts to the power saving mode. When the processing in step S105 or step S106 is completed, the control returns to step S103 and waits for a next job.

Next, the calibration processing is described with reference to FIG. 6. When the apparatus is turned ON or returns from the energy saving mode, a test pattern (for calibration) is irradiated from a laser exposure unit 408 to a photosensitive drum 402. With respect to yellow (Y), magenta (M), cyan (C) and black (K), a latent image of the test pattern is formed on the photosensitive drum, and toners of respective colors are attached from each of the Y, M, C and K developers 403, 404, 405 and 406 of the developing unit 407 to the photosensitive drum. The toner image of the test pattern is transferred to an intermediate transfer belt (ITB) 401 and detected by a toner detection unit 410. Based on the detected values, a correction coefficient Ka of a contrast potential, a grid potential, a development bias potential, a laser exposure potential, and a printer γ coefficient are corrected.

In a case where the printer engine does not have the ITB 401, the toner attached to the photosensitive drum 402 is detected for performing calibration.

The image forming apparatus such as an MFP or a copying machine has a function to register, as default setting, each setting of the copying functions (monochrome/color printing, texts/photograph mode, single-side/double-side printing, output gradation, number of copies, stapling and so on) which is automatically set when the apparatus is started or returns from the power saving mode, or when a predetermined period has elapsed since completion of a previous job.

When color output is performed, calibration is essential to perform high-quality printing. However, when a job requiring printing takes place during calibration, the print processing is forced to wait until the calibration is completed. Even in a case of monochrome output where calibration is not necessary, the print processing is forced to wait until calibration for color processing is completed, and this is inefficient.

In view of this problem, Japanese Patent Application Laid-Open No. 2000-324279 discloses a control for not executing calibration until a job requiring color printing is processed.

According to Japanese Patent Application Laid-Open No. 2000-324279, the processing efficiency improves for monochrome output upon apparatus start-up. However, because calibration is performed upon reception of a job that requires color printing, the calibration execution time is added to the printing time of the first color output. In an image forming apparatus capable of color output and monochrome output, appropriate calibration execution timing is different depending on whether the usage environment of the apparatus mainly involves color output or monochrome output. However, the conventional image forming apparatuses do not take such difference into consideration.

### SUMMARY OF THE INVENTION

The present invention has been made in view of the above-described problem, and has as its object to improve, in an image forming apparatus capable of color output and monochrome output, reduction in a throughput caused by calibration by controlling in accordance with a usage environment the execution timing of calibration performed at the time of apparatus start-up and/or return from an energy saving mode.

According to one aspect of the present invention, there is provided an image forming apparatus having a calibration mechanism that adjusts a printer engine for color output, comprising: a storage unit configured to store main mode data indicative of information on which of color output processing or monochrome output processing is mainly used; and a control unit configured to switch execution or non-execution of calibration processing, performed by the calibration mechanism upon start-up of the apparatus, in accordance with whether the main mode data stored in the storage unit indicates color output processing or monochrome output processing.

Also, according to another aspect of the present invention, there is provided a control method of an image forming apparatus having a calibration mechanism that adjusts a printer engine for color output, comprising: a storing step of storing main mode data in a memory, which indicates information on which of color output processing or monochrome output processing is mainly used; and a controlling step of switching execution or non-execution of calibration processing, performed by the calibration mechanism upon start-up of the apparatus, in accordance with whether the main mode data stored in the memory indicates color output processing or monochrome output processing.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a flowchart describing calibration execution timing-in a general printer;

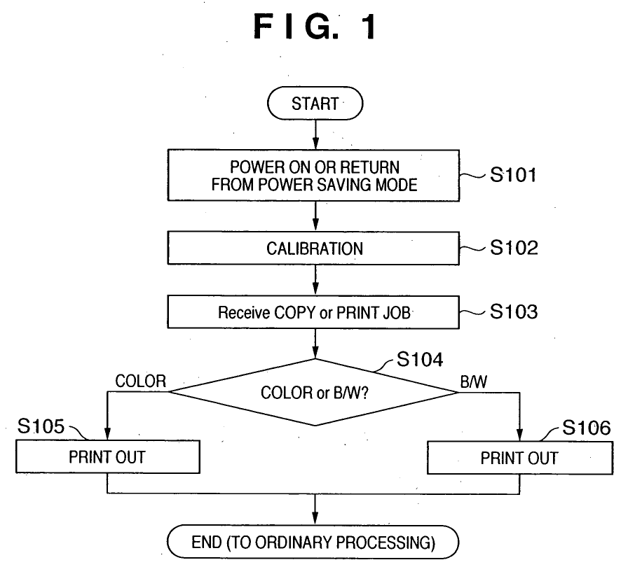

FIG. 2 is a flowchart describing an operation procedure of a printer according to a first embodiment;

FIG. 3 is a flowchart describing an operation procedure of a printer according to a second embodiment;

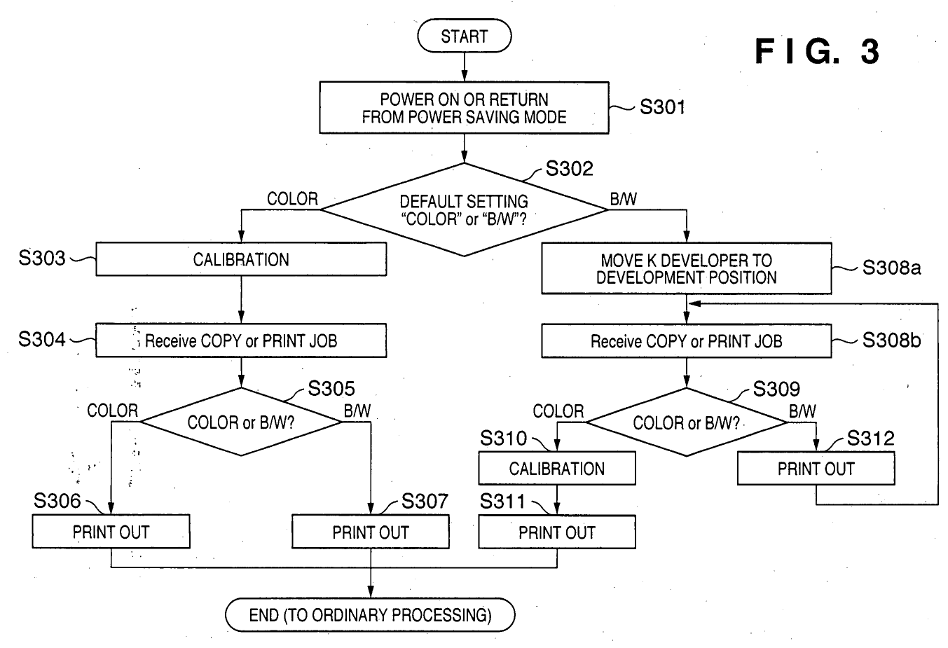

FIG. 4 is a diagram showing the position of developers when default setting is color output; and

FIG. 5 is a diagram showing the position of developers when default setting is monochrome output.

FIG. 6 is a diagram showing a brief configuration of a conventional image forming apparatus.

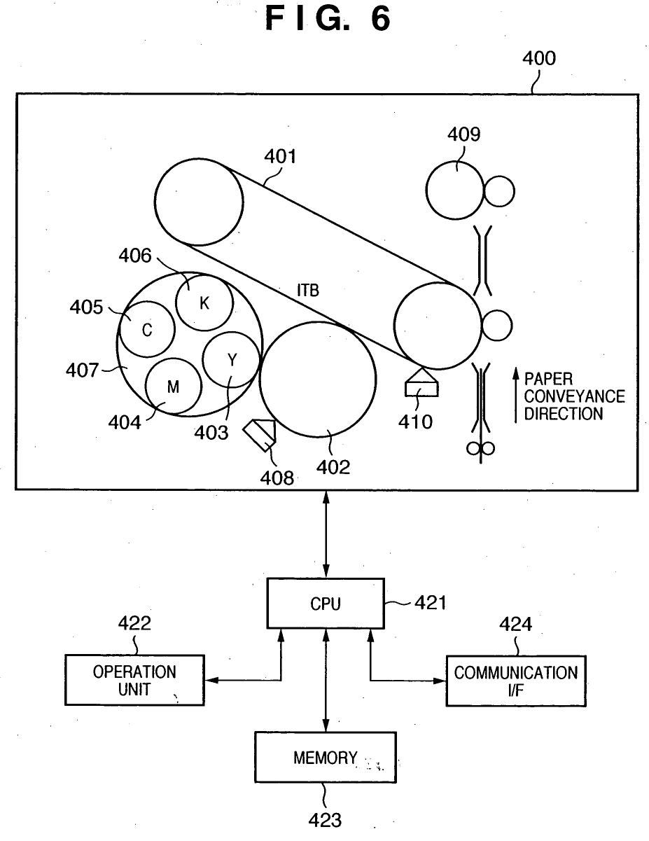

### DETAILED DESCRIPTION OF THE PREFERRED EMBODIMENTS

Preferred embodiments of the present invention will now be described in detail in accordance with the accompanying drawings.

Each of the following embodiments solves the above-described problem by changing the timing of calibration processing performed upon power-ON or return from a sleep mode in accordance with the default setting of monochrome or color output.

### First Embodiment

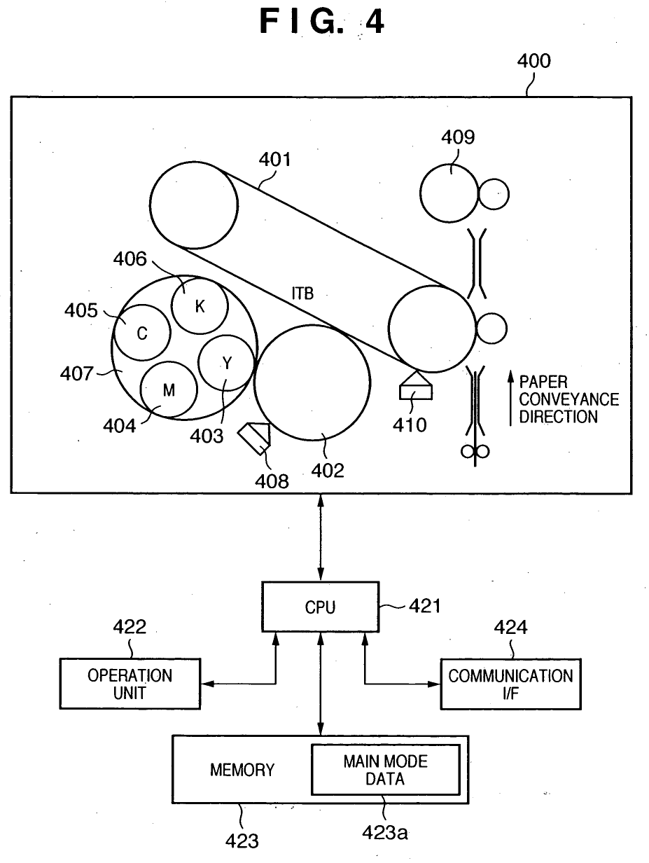

FIG. 4 is a diagram showing a brief configuration of an image forming apparatus according to the present embodiment. In FIG. 4, a printer engine 400 comprises the following configuration. The photosensitive drum 402 forms an electrostatic latent image, corresponding to predetermined color components, by a laser beam irradiated by the laser exposure unit 408. The electrostatic latent image on the photosensitive drum 402 is developed by one of developers 403 to 406 having corresponding color components, and a toner image is formed by toners of corresponding color components. The toner image formed on the photosensitive drum 402 is transferred to the ITB 401. In a case where color print data are processed, after all toner images corresponding to all color components are transferred to the ITB 401, the images on the ITB 401 are transferred, as a color image, to printing paper which is conveyed on a conveyance path. In a case where monochrome print data are processed, after a toner image corresponding to one color (black) is transferred to the ITB 401, the image on the ITB 401 is transferred, as a monochrome image, to printer paper. The printing paper to which the color or monochrome image is transferred is conveyed to a fixing unit 409, and the image is fixed to the printing paper by heat. The toner detection unit 410 is used at the time of calibration operation for detecting density of the toner which is transferred to the ITB 401.

A CPU 421 performs various controls on the printer engine 400 and realizes processing, which will be described later with reference to flowcharts, in accordance with control programs stored in a memory 423. A user operation performed through an operation unit 422 is inputted to the CPU 421 and reflected on each control. A user can use the operation unit 422 to designate, as main mode data 423a which is part of default setting, whether color output or monochrome output is to be mainly used. The default setting designated on the operation unit 422 is stored in the memory 423. A communication interface 424 is connected to an external data processing apparatus for print job reception. The communication interface may be capable of facsimile communication. Also, the external data processing apparatus may be a digital camera connectable to a client computer, a server computer or a printer. In a case where the image forming apparatus is a stand-alone copying machine, a communication I/F is dispensable.

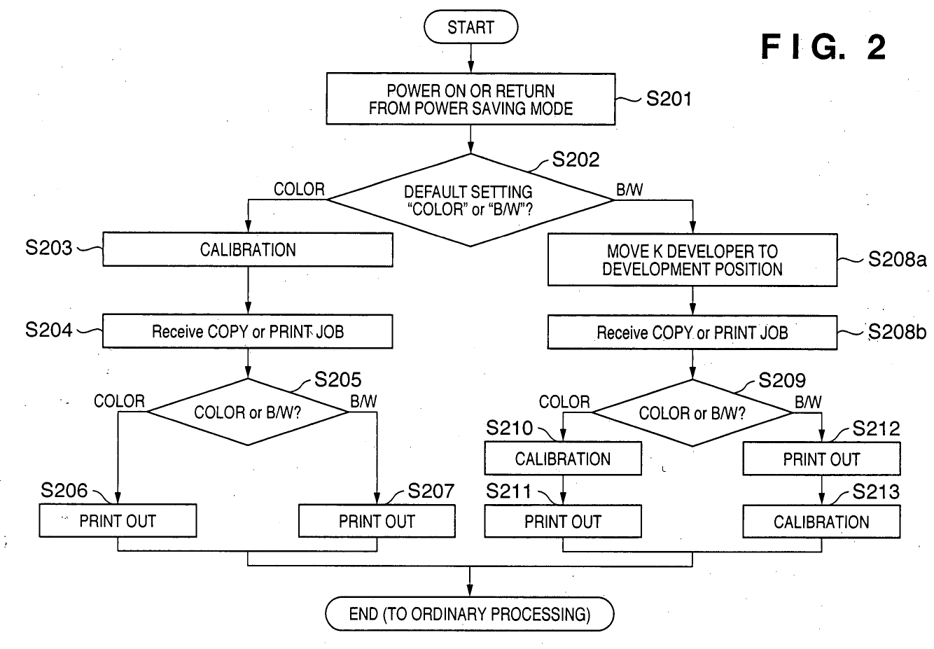

FIG. 2 is a flowchart describing an operation of the image forming apparatus according to the first embodiment.

The image forming apparatus according to the first embodiment has a mechanism for shifting to a power saving mode in a case where print-out processing is not performed for a predetermined period. The power saving mode saves power by a mechanism that turns off the power of the aforementioned printer engine. When such image forming apparatus is turned on or returns from the power saving mode, it is preferable to perform calibration prior to color output. As the preferable timing to perform calibration, the first embodiment takes an example of the apparatus start-up timing (including when power is turned on and when the apparatus returns from the power saving mode).

When the image forming apparatus is turned on and/or returns from the power saving mode (step S201), default setting for printing which is set by the user or set upon shipment is read from the memory 423.

Processing differs depending on whether the main mode data 423a included in the default setting read from the memory 423 indicates color output or monochrome output (step S202). When the default setting (main mode data 423a) is color output, calibration is performed (step S203) to correct the hue of the color output of the printer engine and toner output density of respective toners for yellow (Y), magenta (M), cyan (C) and black (K). Upon completion of the calibration, a developer having a color toner to be transferred first is set at the position adjacent to the photosensitive drum 402 so as to realize quick execution of color printing. In the example shown in FIG. 4, the Y developer 403 is transferred first, and then the developing unit 407 rotates to develop in order of Y, M, C and K for transferring respective toners.

When a job requiring printing such as copying or printing is received after the calibration is completed (step S204), color output is performed for a color printing job (step S205 and S206) or monochrome output is performed for a monochrome printing job (step S205 and S207). If a job requiring printing such as copying or printing is received before the calibration is completed, the printing is forced to wait until the calibration is completed regardless of whether the job is a color printing job or a monochrome printing job. As soon as the calibration is completed, the printing operation is started.

Thereafter the control proceeds to ordinary processing. In ordinary processing, color output or monochrome output is performed in accordance with job reception (steps S204 to S207).

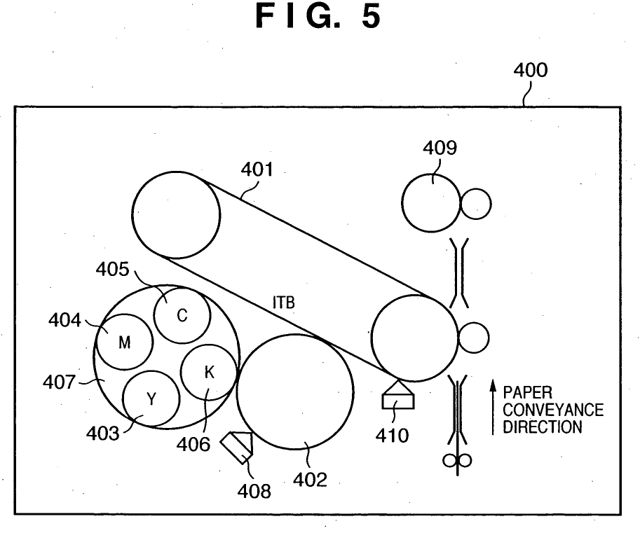

Meanwhile, if the default setting (main mode data 423a) is monochrome output (step S202), calibration is not performed, but the K developer 406 is set at the position adjacent to the photosensitive drum 402 (step S208a) as shown in FIG. 5. Then, when a job requiring printing such as copying or printing is received (step S208b), whether the job is color output or monochrome output is determined (step S209). If the job is color output, necessary calibration is performed (step S210) and then printing for the job is performed (step S211). If the job is monochrome output, printing is immediately performed without performing calibration (step S212). After the job for monochrome output is completed, calibration is performed (step S213), and the K developer of the developing unit 407 is again set at the position adjacent to the photosensitive drum.

After calibration is performed in accordance with default setting (after step S203, S210, S213), the control proceeds to the ordinary job control flow, and calibration will not be performed until power is turned off or the apparatus shifts to the power saving mode. In a case where there is a job to be processed after printing is completed in step S212, the printing for the job may be performed in succession. According to the above control, in a case where monochrome output jobs are continuously received upon apparatus start-up, calibration can be performed after the received jobs are completed. Therefore, processing efficiency improves.

Note that in the aforementioned ordinary processing, assume that the position of the developer is controlled in accordance with default setting set in the memory 423. For instance, in a case where default setting is monochrome output, the K developer 406 is moved to the position adjacent to the photosensitive drum 402 after color output is completed and the apparatus is in a stand-by state. In the construction shown in FIGS. 4 and 5, since images are formed in order of Y, M, C and K, the K developer 406 ultimately comes to the position adjacent to the photosensitive drum 402. Therefore, this state is maintained. In a case where default setting is color output, the Y developer 403 is moved to the position adjacent to the photosensitive drum 402 after color output or monochrome output is completed.

### Second Embodiment

Next, the second embodiment is described. In the first embodiment, calibration is performed after monochrome output is completed. In the second embodiment, the image forming apparatus is controlled not to perform calibration until a color output job is received. The image forming apparatus according to the second embodiment has the same configuration as that of the first embodiment (FIG. 4).

When the image forming apparatus is turned on or returns from the power-saving mode (step S301), default setting for printing which is set by the user or set upon shipment is read from the memory 423. Processing differs depending on whether the default setting read from the memory 423 indicates color output or monochrome output (step S302).

When the default setting (main mode data 423a) is color output, calibration is performed (step S303) to correct the hue of the color output of the printer engine and toner output density of respective toners for yellow (Y), magenta (M), cyan (C) and black (K). Upon completion of the calibration, a developer having a color toner to be transferred first is set at the position adjacent to the photosensitive drum 402 so as to realize quick execution of color printing. In the example shown in FIG. 4, the Y developer 403 is transferred first, and then the developing unit 407 rotates to develop in order of Y, M, C and K for transferring respective toners.

When a job requiring printing such as copying or printing is received after the calibration is completed (step S304), color output is performed for a color printing job (step S305 and S306) or monochrome output is performed for a monochrome printing job (step S305 and S307). If a job requiring printing such as copying or printing is received before the calibration is completed, the printing is forced to wait until the calibration is completed regardless of whether the job is a color printing job or a monochrome printing job. As soon as the calibration is completed, the printing operation is started.

Thereafter the control proceeds to ordinary processing similar to the first embodiment. In ordinary processing, color output or monochrome output is performed in accordance with job reception (steps S304 to S307).

Meanwhile, if the default setting (main mode data 423a) is monochrome output (step S302), calibration is not performed, but the K developer 406 is set at the position adjacent to the photosensitive drum 402 (step S308a) as shown in FIG. 5. Then, when a job requiring printing such as copying or printing is received (step S308b), whether the job is color output or monochrome output is determined (step S309). If the job is color output, necessary calibration is performed (step S310) and then printing for the job is performed (step S311). Then, the control proceeds to ordinary processing.

If the job is monochrome output, printing is immediately performed (step S312). After the job for monochrome output is completed, the control returns to step S308b. Thereafter, the control repeats the above-described processing (step S308b, S309, S312) until a color output job is received. In a case of executing a color output job, the control proceeds from step S309 to S310 to perform calibration.

After calibration is performed, the control proceeds to the ordinary job control flow, and calibration will not be performed until power is turned off or the apparatus shifts to the power saving mode.

As described above, according to the second embodiment, in a case where default setting is monochrome output, calibration is not performed until a color output job is received. Therefore, processing efficiency improves in a case where monochrome output jobs are continuously received upon apparatus start-up.

Note in each of the above-described embodiments, although the default setting value is stored in the memory 423, a default value may be designated by a mechanical switch on the operation unit 422. Alternatively, a default value may automatically be set by taking statistics on monochrome output execution and color output execution.

As has been set forth above, according to the present invention, in an image forming apparatus capable of color output and monochrome output, the execution timing of calibration performed at the time of apparatus start-up and/or return from an energy saving mode is controlled in accordance with a usage environment, and therefore it is possible to improve reduction in a throughput caused by calibration.

As many apparently widely different embodiments of the present invention can be made without departing from the spirit and scope thereof, it is to be understood that the invention is not limited to the specific embodiments thereof except as defined in the appended claims.

### Claim of Priority

This application claims priority from Japanese Patent Application No. 2004-054640 filed on Feb. 27, 2004, which is hereby incorporated by reference herein.

1. An image forming apparatus having a calibration mechanism that adjusts a printer engine for color output, comprising:
a storage unit configured to store main mode data indicative of information on which of color output processing or monochrome output processing is mainly used; and
a control unit configured to switch execution or non-execution of calibration processing, performed by the calibration mechanism upon start-up of said apparatus, in accordance with whether the main mode data stored in said storage unit indicates color output processing or monochrome output processing.

2. The apparatus according to claim 1, further comprising a setting unit configured to cause a user to set as a main mode either color output processing or monochrome output processing,
wherein said storage unit stores a result of setting by said setting unit.

3. The apparatus according to claim 1, wherein said control unit executes the calibration processing upon start-up of said apparatus in a case where the main mode data indicates color output processing, and executes the calibration processing in accordance with execution of a printing job in a case where the main mode data indicates monochrome output processing.

4. The apparatus according to claim 3, wherein in a case where the main mode data indicates monochrome processing, said control unit executes the calibration processing when a job requiring color output processing is to be processed for the first time since said apparatus started-up.

5. The apparatus according to claim 4, wherein in a case where the main mode data indicates monochrome processing, said control unit-further executes the calibration processing immediately after a job requiring monochrome output processing is processed for the first time since said apparatus started-up.

6. The apparatus according to claim 1, wherein the start-up of said apparatus includes the time at which power is turned on and said apparatus returns from a power saving mode.

7. The apparatus according to claim 1, wherein the printer engine has a plurality of developing units corresponding to respective color components for forming a color image, and forms a color image by sequentially moving the plurality of developing units to a predetermined development position, and
said apparatus further comprises an arrangement control unit configured to control arrangement so that, in a case where the main mode data indicates monochrome output, a black developing unit is arranged at a position closest to the development position in a stand-by state.

8. The apparatus according to claim 7, wherein in a case where the main mode data indicates color output, said arrangement control unit controls arrangement so that a developing unit corresponding to a color subjected to first image forming in the color image forming is arranged at a position closest to the development position in a stand-by state.

9. A control method of an image forming apparatus having a calibration mechanism that adjusts a printer engine for color output, comprising:
a storing step of storing main mode data in a memory, which indicates information on which of color output processing or monochrome output processing is mainly used; and
a controlling step of switching execution or non-execution of calibration processing, performed by the calibration mechanism upon start-up of the apparatus, in accordance with whether the main mode data stored in the memory indicates color output processing or monochrome output processing.

10. An image processing method of a color image forming apparatus where a black developer is set at a position adjacent to a photosensitive unit, wherein in a case where a received job is a monochrome job, printing corresponding to the job is performed without performing calibration.
